(19) United States
(12) Patent Application Publication
(10) Pub. No.: US 2013/0113898 A1
(43) Pub. Date: May 9, 2013

(54) IMAGE CAPTURING APPARATUS

(71) Applicants: Kei Tokui, Osaka-shi (JP); Sakae Saito, Osaka-shi (JP)

(72) Inventors: Kei Tokui, Osaka-shi (JP); Sakae Saito, Osaka-shi (JP)

(73) Assignee: SHARP KABUSHIKI KAISHA, Osaka-shi, Osaka (JP)

(21) Appl. No.: 13/809,597

(22) PCT Filed: May 24, 2011
(86) PCT No.: PCT/JP2011/061842

§ 371 Date: Jan. 11, 2013

(30) Foreign Application Priority Data
Jul. 14, 2010 (JP) 2010-159925

(51) Int. Cl. H04N 13/02

(52) U.S. Cl. CPC H04N 13/0239
USPC 348/50

(57) ABSTRACT

Disclosed is an image capturing apparatus which is capable of obtaining a three-dimensional image in either a vertical or horizontal position. The image capturing apparatus is provided with two imaging elements, and an image processing portion which uses the images imaged by the imaging elements to generate a three-dimensional image. The image processing portion calculates the parallax between a first and a second image, imaged by the imaging elements, and uses the first image to generate an estimated image having parallax in the direction orthogonal to the arrangement direction of the imaging elements, relative to the first image, and generates a three-dimensional image from the calculated parallax and the estimated image.

### TECHNICAL FIELD

The present invention relates to a technology concerning an image capturing apparatus, and particularly to a technology of capturing and displaying a three-dimensional image.

### BACKGROUND OF THE INVENTION

A three-dimensional image technology has been developed in which an image for a left eye is visually recognized with a left eye while an image for a right eye is visually recognized with a right eye, and a three-dimensional image is recognized due to a deviation of subjects in both of the images (parallax). Some displays for displaying a three-dimensional image, in combination with glasses for viewing the three-dimensional image, display right and left images in time division and display by changing a polarization direction, thereby allowing a viewer to visually recognize the right and left images separately. In addition, some cameras for shooting a three-dimensional image are provided with two solid-state imaging elements such as a CMOS (Complementary Metal Oxide Semiconductor) and a CCD (Charge Coupled Device) to arrange the imaging elements right and left, respectively, for having shot images as images for a left eye and for a right eye, respectively.

However, it is impossible to shoot a three-dimensional image in a vertical position with a camera in which two imaging elements are arranged right and left. For example, in FIG. 13 showing normal shooting, a longitudinal direction of an imaging element is the same as a direction in which two imaging elements are arranged, so that it is possible to shoot an image for a left eye and an image for a right eye. In FIG. 14 showing imaging elements in a vertical position in the camera of FIG. 11, which are arranged vertically, thereby shooting of right and left images is not allowed.

A method for solving the problem includes a method for rotating an imaging element itself, which is shown in Patent document 1, for example. Patent document 1 discloses, as shown in FIG. 15, a compound-eye camera apparatus provided with camera heads 3a and 3b supported rotatably by a camera body 4, a plurality of shooting lenses 1a and 1b supported by the camera heads 3a and 3b, respectively, and imaging elements 2a and 2b. The compound-eye camera apparatus is configured for normal shooting as shown in FIG. 15 (A), while for shooting in a vertical position as shown in FIG. 15 (B). From FIG. 15 (A) to FIG. 15 (B), the imaging elements 2a and 2b are rotated so that a short direction of the imaging elements becomes equal to a direction in which the imaging elements are arranged (right and left), thereby making it possible to shoot right and left images in shooting in the vertical position.

### PRIOR ART DOCUMENT

### Patent Document

### Patent Document 1: Japanese Laid-Open Patent Publication No. 10-224820

### SUMMARY OF THE INVENTION

### Problems to be Solved by the Invention

However, the above-described method has the following problem.

In the configuration of the Patent document 1, since it is necessary to physically rotate imaging elements, a mechanism for rotation, a space for allowing rotation, and a rotation-proof wiring are required, resulting in a larger, more complicated, and higher-cost apparatus.

The present invention has been devised in view of the above-described circumstances, and an object thereof is to provide an image capturing apparatus capable of generating and displaying a three-dimensional image in either a vertical position or a horizontal position without making an apparatus larger.

### Means for Solving the Problem

An image capturing apparatus of the present invention, comprising: two imaging elements; and an image processing portion which generates an image, wherein the image processing portion calculates parallax between a first image and a second image captured by the imaging elements, generates an estimation image having parallax in a direction orthogonal to an arrangement direction of the imaging elements with respect to the first image using the calculated parallax and the first image, and generates a three-dimensional image from the estimation image.

The image capturing apparatus of the present invention, wherein the image processing portion switches between processing of generating a three-dimensional image generated from the estimation image having parallax in the direction orthogonal to the arrangement direction of the imaging elements as a first three-dimensional image; and processing of generating a second three-dimensional image from the first and the second images captured by the imaging elements, or from an estimation image that is generated from the first and the second images captured by the imaging elements, and has parallax in the arrangement direction of the imaging elements.

The image capturing apparatus of the present invention, wherein the image capturing apparatus includes an image display portion which displays the three-dimensional image generated by the image processing portion and a light control portion which controls advance of image light of the respective two images from which the three-dimensional image is generated when the image display portion displays the three-dimensional image, and the light control portion switches control of the advance of the image light according to the first three-dimensional image and the second three-dimensional image which are displayed, respectively.

The image capturing apparatus of the present invention, wherein the image capturing apparatus includes a posture detecting portion which detects posture of the image capturing apparatus, and the image processing portion switches between processing of generating the first three-dimensional image and processing of generating the second three-dimensional image according to the posture of the image capturing apparatus detected by the posture detecting portion.

### Effect of the Invention

According to the present invention, it becomes possible to obtain a three-dimensional image in either a vertical position or a horizontal position without making an apparatus larger. In addition, an image display portion which realizes visual recognition of a three-dimensional image by controlling advance of light is provided, thus making it possible to perform shooting while confirming a subject as a three-dimensional image by the image display portion. Further, posture of the imaging apparatus is detected by a posture detecting portion, thereby making it possible to automatically switch orientation of right and left images which forma three-dimensional image.

### BRIEF DESCRIPTION OF DRAWINGS

FIG. 1 is a block diagram showing an embodiment of an image capturing apparatus of the present invention.

FIG. 2 is a diagram showing a configuration example of an image processing portion of FIG. 1.

FIG. 3 is a diagram for illustrating an example of a method for calculating parallax information.

FIG. 4 is a diagram for illustrating image estimation processing by parallax conversion.

FIG. 5 is a diagram showing a setting example of relation between parallax and a movement amount of pixels.

FIG. 6 is a diagram for illustrating image estimation processing by parallax conversion.

FIG. 7 is a diagram showing an example of three-dimensional image information corresponding to a parallax barrier.

FIG. 8 is a diagram showing another example of three-dimensional image information corresponding to the parallax barrier.

FIG. 9 is a diagram showing a three-dimensional display using the parallax barrier.

FIG. 10 is a diagram showing a state of the parallax barrier corresponding to a three-dimensional image.

FIG. 11 is a block diagram showing another embodiment of the image capturing apparatus of the present invention.

FIG. 12 is a diagram showing another example of arrangement relation of imaging elements which is applicable to the image capturing apparatus of the present invention.

FIG. 13 is a diagram showing an arrangement example of imaging elements of the image capturing apparatus.

FIG. 14 is a diagram showing arrangement where the imaging elements of FIG. 13 are placed vertically.

FIG. 15 is a diagram showing a technology described in Japanese Laid-Open Patent Publication No. 10-224820.

### PREFERRED EMBODIMENTS OF THE INVENTION

Description will hereinafter be given in detail for embodiments of the present invention with reference to drawings. Note that, representation in each diagram is exaggeratingly given for easy understanding, thus being different in practical application in some cases.

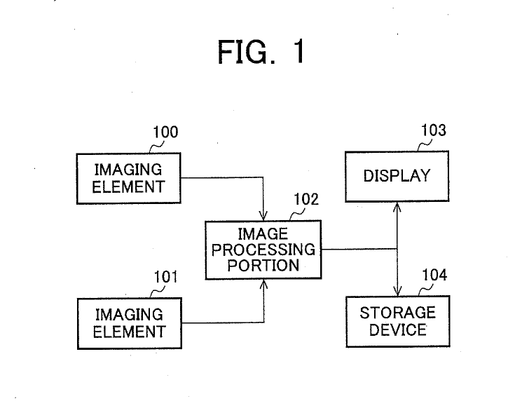

FIG. 1 is a block diagram showing a configuration example of the image capturing apparatus of the present invention. The image capturing apparatus is provided with two imaging elements of an imaging element 100 and an imaging element 101. In an image processing portion 102, images which are shot by the imaging elements 100 and 101 are subjected to basic image processing such as demosaicing, color conversion, and gamma correction as well as image processing required for a three-dimensional image which is described below. Image information which is output from the image processing portion 102 is displayed on a display (image display portion) 103 capable of three-dimensional display and recorded in a storage device 104.

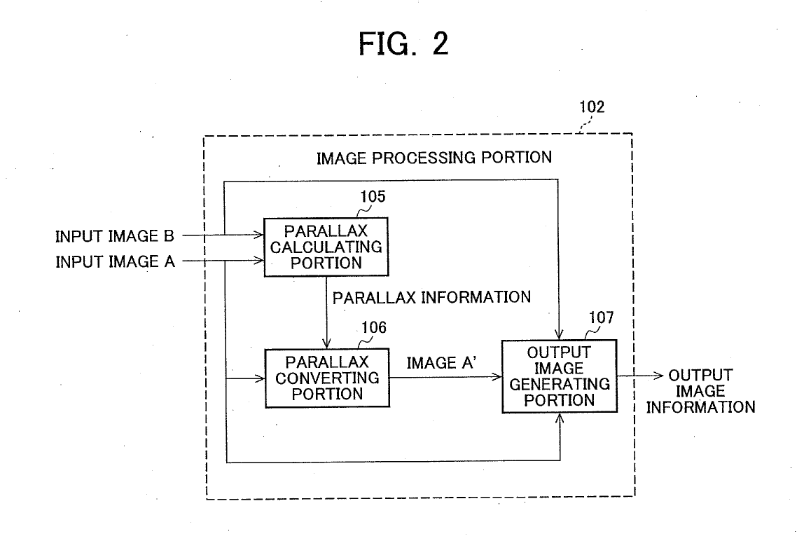

FIG. 2 is a diagram showing a processing block of the image processing portion 102. Input images are two images of A and B which are shot in different positions, corresponding to a first image and a second image in the present invention. First, parallax information is calculated as information which is obtained from a shot image by a parallax calculating portion 105. Parallax is determined by an interval between cameras arranged parallel (base line length) and a focal length of and a distance to a subject from the cameras, and parallax becomes larger as a distance to the subject is smaller, and parallax becomes smaller as a distance to the subject is larger.

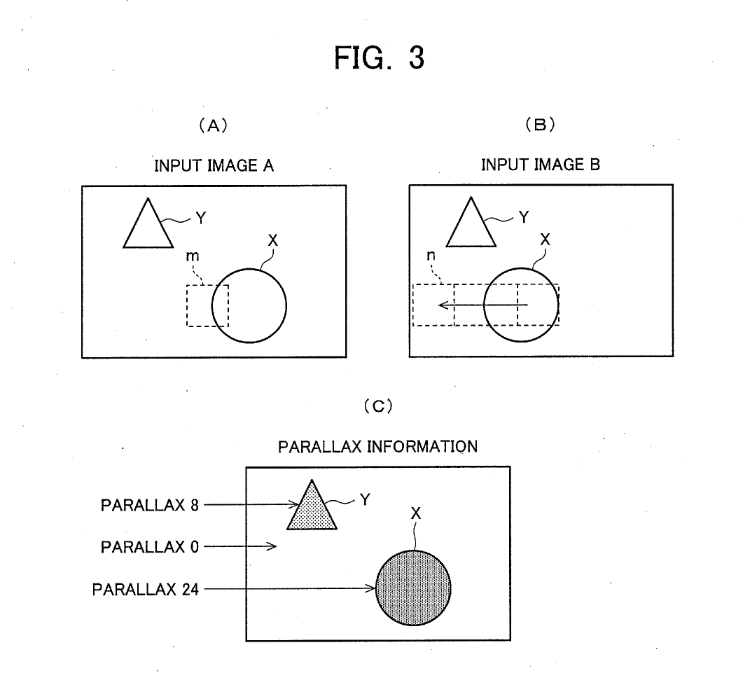

Various methods are applicable to calculation of parallax, including a block matching method, for example. FIG. 3 is a diagram showing an outline of block matching, showing an input image A which is shot by an imaging element (camera) arranged on a left side in FIG. 3 (A), an input image B which is shot by an imaging element (camera) arranged on a right side in FIG. 3 (B), and parallax information calculated from the input images A and B in FIG. 3 (C).

Here, an arbitrary reference macroblock m is defined in the input image A while a search macroblock n having the same size as the reference macroblock m is defined in the input image B which is shot by the imaging element (camera) arranged on a right side. While moving the search macroblock n in the input image B, sum of absolute differences between the reference macroblock m and the search macroblock n is calculated, resulting in a difference of coordinates between the input image A and the input image B as parallax having the smallest sum of absolute differences. In FIG. 3, when a subject X in the input image A is shifted by 24 pixels in a horizontal direction in the input image B, parallax of the subject X is regarded as 24. Similarly, when a subject Y far away from the subject X is shifted by eight pixels in a horizontal direction, parallax of the subject Y is regarded as 8.

The parallax information calculated by the parallax calculating portion 105 is transmitted to a parallax converting portion 106. The parallax converting portion 106 uses the input image and the parallax information to estimate and generate an image which is shot at a position different from that of the input image.

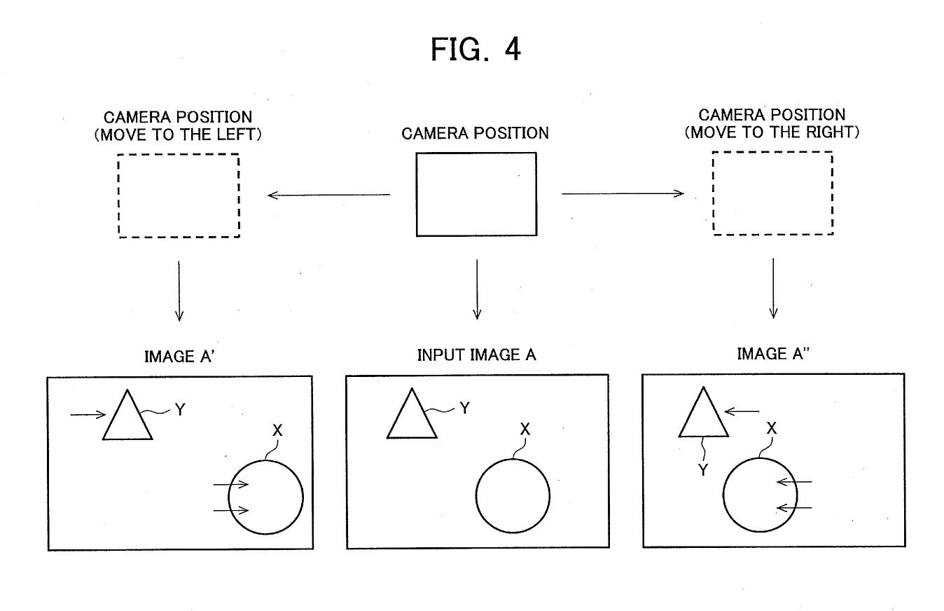

For example, as shown in FIG. 4, according to size of parallax corresponding to each pixel of the input image A, a pixel value is moved to the right. An image generated at the time is A′, in which the subject X having a large parallax value moves greatly, the subject Y having a small parallax value moves slightly, and a background region having no parallax does not move. This results in estimating an image which is shot at a camera position moved to the left from a camera position where the input image A is shot. Similarly, movement of pixels to the left results in estimating an image which is shot at a camera position moved to the right. Further, movement to the left by parallax corresponding to each pixel results in estimating a shot image at a position where the input image B is shot.

Description will be given for a processing example in generating the image A′ from the input image A and the parallax information. Here, a maximum parallax value is assumed to be 255. X and Y are provided as subjects of the input image A, and a parallax value of X and a parallax value of Y are assumed to be 24 and 8, respectively. When the image A′ at the position of the input image B is created, a movement amount of the subject X is 24 and parallax of a three-dimensional image is 24 while a movement amount of the subject Y is 8 and parallax of a three-dimensional image is 8.

The image A′ may be generated at a position half a base line length (interval between cameras) from the image A to the image B having a movement amount of each pixel as a half of the base line length of 1. For example, the movement amount of the subject X is 12 and parallax of a three-dimensional image is 12 while the movement amount of the subject Y is 4 and parallax of a three-dimensional image is 4.

That is, it is possible to generate the image A′ by moving the subjects according to a parallax value of each pixel.

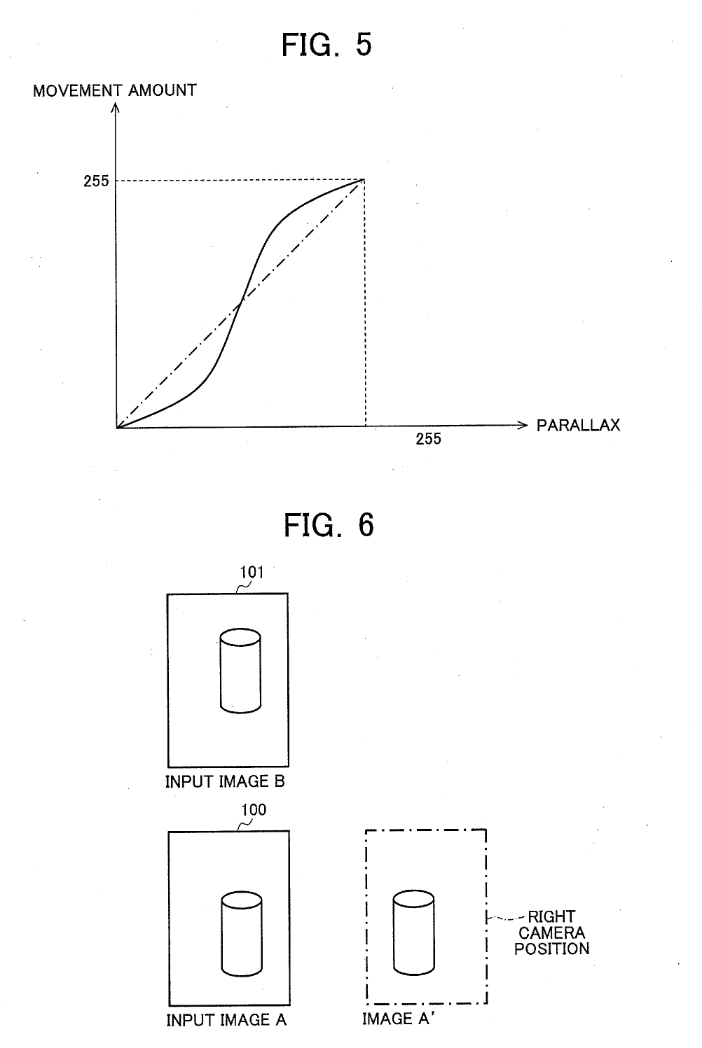

Moreover, in addition to the above-described processing, it is also possible to have a three-dimensional image in which a stereoscopic effect of a main subject is emphasized by further increasing contrast of parallax. For example, relation between parallax and a movement amount may be set as relation as shown in FIG. 5 rather than linear relation as described above. In this case, a movement amount of a subject in a foreground with large parallax becomes large and a movement amount of a background with small parallax becomes small, so that contrast of parallax between the foreground and the background becomes large. Thereby, it is possible to obtain a three-dimensional image in which a stereoscopic effect of a main subject with moderate level of parallax is emphasized.

In addition, in order to control a stereoscopic effect of a three-dimensional image, processing for uniformly moving one or both images may be added. For example, in FIG. 3, when all pixels of the input image B are moved to the right by eight pixels, parallax between the input image A and the input image . B is 16 for the subject X, 0 for the subject Y, and −8 for the background. At the time, in displaying as a three-dimensional image on a display, in the case of having a plus sign in parallax, the subject appears protruded from a display surface, while the subject appears recessed from the display surface in the case of having a plus sign in parallax.

The subject is moved by the above-described processing, thereby making it possible to estimate and generate an image which is shot at a position different from that of an input image.

In this case, although unspecified pixels in which corresponding pixel values do not exist are sometimes generated after a subject moves, a region thereof is interpolated by surrounding pixel values, so that it is possible to avoid deterioration of image quality. In particular, when a subject moves to the right as shown in the image A′, an unspecified pixel is generated on the left side of the subject moving. A pixel value on the left side of the unspecified pixel is provided for background, thus preferably making it possible to reduce deterioration of image quality by interpolating with the pixel value on the left side. When a camera moves to the right, right-left reversed happens, while it is possible to reduce deterioration of image quality. By the method described above, the parallax converting portion 106 generates and outputs the image A′ in which parallax of the input images is converted from the input image and parallax information.

An output image generating portion 107 performs image processing for displaying and saving. When a three-dimensional image is displayed on the display 103, it is necessary to generate data corresponding to a display system of the display 103. For example, in a system in which a polarization direction is changed for each line of a display, it is necessary to insert, for each line, two images corresponding to right and left images to make one image. Moreover, in a system of displaying right and left images in time division, it is necessary to have a frame configuration in which two images corresponding to right and left images are alternated. Further, in the case of saving in the storage device 104 as image data, it is necessary to convert and compress two images corresponding to right and left images, a color image as reference, parallax information, and the like according to a file format corresponding to a three-dimensional image.

In this case, there are three kinds of images to be input to the output image generating portion 107, which are the input image A and the input image B which are shot by the two imaging elements 100 and 101 provided in the image capturing apparatus, and the image A′ for which the input images are subjected to parallax conversion. Output image information having the input image A and the input image B as left and right images provides a three-dimensional image which is shot by the two imaging elements 100 and 101. The image A′ subjected to parallax conversion corresponds to a second estimation image of the present invention, and the obtained three-dimensional image corresponds to a second three-dimensional image of the present invention.

Output image information having the input image B and the image A′ as left and right images provides a three-dimensional image in which parallax of the images which are shot by the two imaging elements is adjusted. At the time, when such processing is performed that the image A′ is subjected to parallax conversion to get closer to a position at which the input image B is shot, conversion processing is brought such that parallax of a subject becomes small and an amount of protrusion (recess) of the three-dimensional image becomes small. On the other hand, when such processing is performed that the image A′ is subjected to parallax conversion to get away from the position at which the input image B is shot, conversion processing is brought such that parallax of a subject becomes large and an amount of protrusion (recess) of the three-dimensional image becomes large. In addition, a movement amount of an image is devised for parallax information, for example, as described above, contrast between parallax included in the main subject and parallax included in the background and the foreground is made larger, thereby obtaining a three-dimensional image in which a stereoscopic effect of the main subject is emphasized. Left and right images may be the input image A and the image A′.

Although description has hereinbefore been given for the case where the longitudinal direction of the imaging element is horizontal to the arrangement direction of two imaging elements, hereinafter, description will be given for a case where the longitudinal direction of the imaging element is vertical to the arrangement direction of two imaging elements, that is, shooting in the vertical position.

There is an occasion of shooting by an image capturing apparatus in a vertical position such as the case of shooting a standing person, however, it is impossible to shoot a three-dimensional image by a normal image capturing apparatus provided with two imaging elements. In this case, in shooting by the imaging element 100 and the imaging element 101 arranged right and left in the vertical position as shown in FIG. 6, the imaging element 100 and the imaging element 101 are forced to be arranged in a vertical direction. In order to obtain a three-dimensional image in shooting in the vertical position, in the case of having the imaging element 100 provided for an image for a left eye, there should be a shot image by the imaging element arranged at a right camera position in FIG. 6.

However, it is possible to calculate parallax of shot images from the imaging element 100 and the imaging element 101. This is because parallax is a value which changes depending on a distance to a subject, and parallax between the imaging element 100 and the imaging element 101 is generated in a vertical direction. Accordingly, it is possible to calculate parallax information by the parallax calculating portion 105 even in shooting in a vertical position.

Next, the input image A shot by the imaging element 100 and the parallax information calculated from the imaging element 100 and the imaging element 101 are input to the parallax converting portion 106. When a three-dimensional image is desired to be obtained by shooting in a vertical position, an image which is shot at a position in a direction perpendicular to a direction in which parallax information is calculated, that is, in a horizontal direction, is estimated.

As an original input image for generating an estimation image, the input image B may be used. As parallax information at the time, it is better to use parallax information which is calculated using the input image B as reference. Thereby, it is possible to use the input image A or B and parallax information to generate an estimation image in a direction perpendicular to the array direction of the imaging elements.

The image A′ generated by the parallax converting portion 106 is transmitted to the output image generating portion 107, and right and left images are selected as output image information. In the case of shooting in a horizontal position, one of the right and left images is provided as the input image B and the other as the input image A or the image A′. In the case of shooting in a vertical position, the right and left images are provided as the input image A and the image A′ in combination. The image A′ is generated from the input image A, however, since parallax conversion processing is performed so that parallax is generated in a subject by parallax information calculated from the input image A and the input image B, parallax is generated also between the input image A and the image A′. Accordingly, a three-dimensional image is allowed to be generated with combination of the input image A and the image A′. The three-dimensional image corresponds to a first three-dimensional image of the present invention.

The method in the above allows generation of a three-dimensional image also in the vertical position even by a small and low-cost image capturing apparatus without physically rotating imaging elements. In addition, it is possible to execute generation processing of a three-dimensional image switched between in a horizontal position and a vertical position.

On the other hand, also in a case where output image information which is output from the image processing portion 102 is displayed on the display 103, a direction of parallax caused in the right and left images is also changed between shooting in a horizontal position and shooting in a vertical position. In a mobile device such as a compact digital camera or a mobile phone with a camera, for a display capable of three-dimensional display, a system capable of three-dimensional display for naked eyes for which a user is not required to wear glasses is preferably provided.

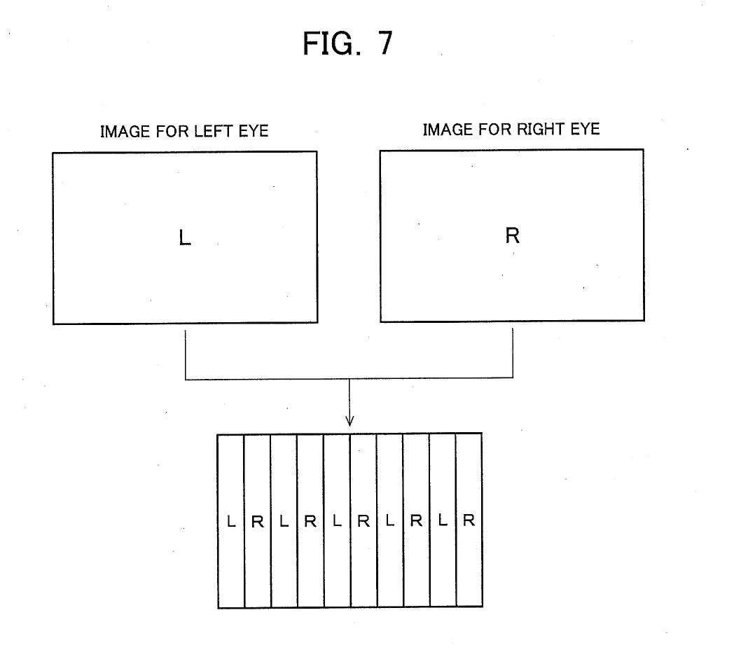

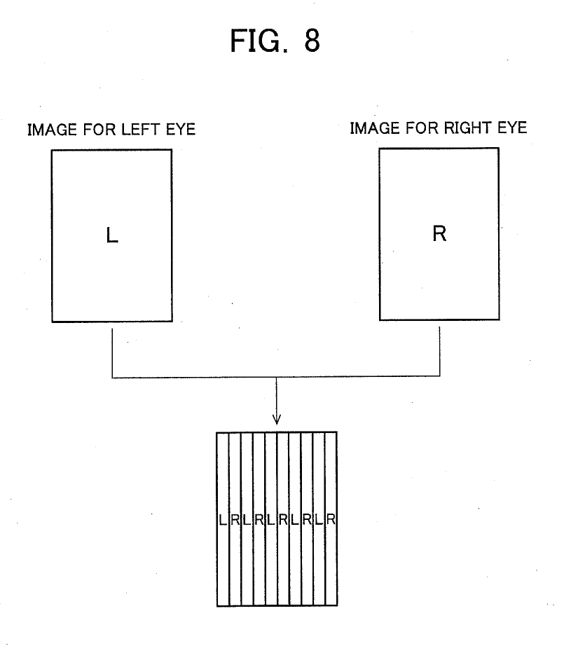

In order to allow a three-dimensional image to be visually recognized with naked eyes, in the display 103, an advancing direction of light is limited so that light of right and left images reaches only one of the respective eyes. For example, in the case of a three-dimensional image in the horizontal position, an image for a left eye L and an image for a right eye R are converted to be alternated such as L, R, L, R . . . for each line as shown in FIG. 7. In addition, also in the case of a three-dimensional image in the vertical position, conversion is performed so that an image for a left eye L and an image for a right eye R are alternated as shown in FIG. 8.

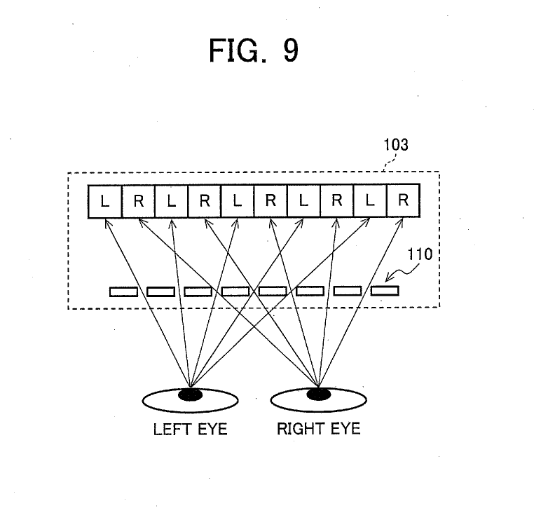

Then, as shown in FIG. 9, a light control portion (parallax barrier 110) for controlling advance of image light is arranged so that light of pixels of the image for a left eye L and the image for a right eye R reaches the left eye and the right eye, respectively. This makes it possible to provide three-dimensional display with naked eyes. In this case, a liquid crystal is used for the parallax barrier 110. For example, a light transmission region of a liquid crystal panel is controlled by using a light shutter effect of the liquid crystal panel, thereby making it possible to electrically control to generate or eliminate the parallax barrier 110. That is, it is possible to electrically switch between two-dimensional image display and three-dimensional image display on the same the display 103.

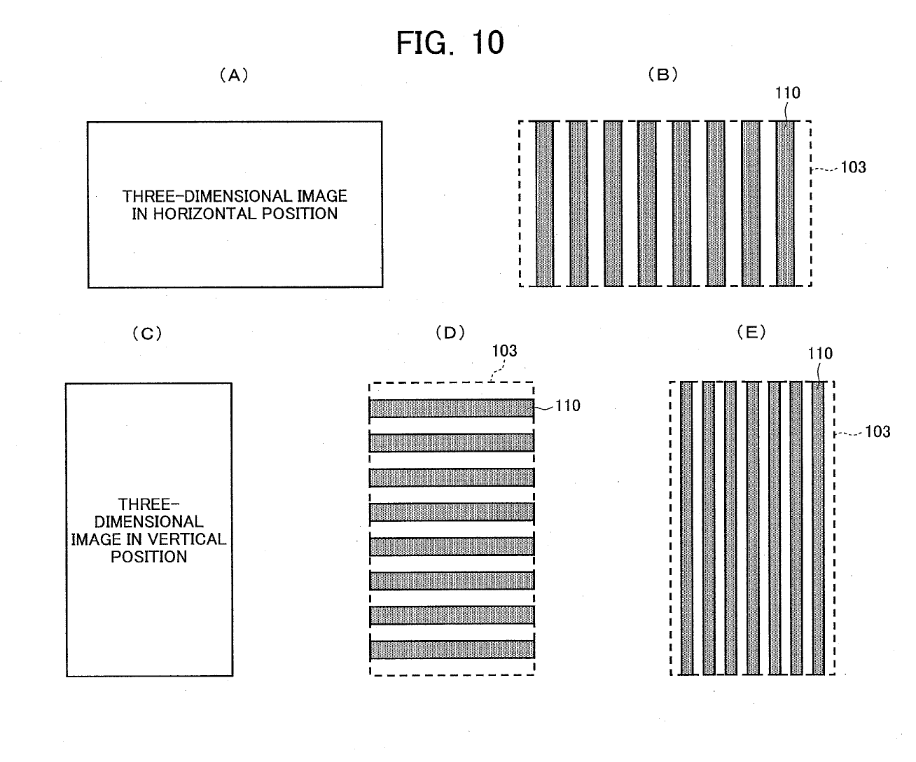

FIG. 10 is a diagram showing states of a three-dimensional image and a parallax barrier. In the case of three-dimensional display of a three-dimensional image in the horizontal position (FIG. 10(A)), the parallax barrier 110 is brought into a state of FIG. 10(B), so that three-dimensional display is allowed. On the other hand, in the case of three-dimensional display of a three-dimensional image in the vertical direction (FIG. 10(C)), it is necessary to control generation of the parallax barrier 110. A state of the parallax barrier 110 as shown in FIG. 10(B) is changed into the vertical direction, thereby changing to a state as shown in FIG. 10(D). In the state, it is impossible to visually recognize the three-dimensional image in the vertical position as a three-dimensional image. Therefore, a liquid crystal is controlled so that a direction of a stripe constituted by the parallax barrier 110 becomes a vertical direction, thereby obtaining a state of the parallax barrier 110 as in FIG. 10(E). Thereby, it becomes possible to display the three-dimensional image in the vertical position (FIG. 10(C)) as a three-dimensional image.

In this case, a three-dimensional display in a time division system is also applicable to a display for displaying a three-dimensional image, and able to be realized by controlling displaying on a display and glasses in synchronization.

Further, in the embodiment, description has been given that a three-dimensional image is generated with the input image A and the image A′, thereby making it possible to shoot a three-dimensional image in the vertical position, however, an image A″ which is different from the image A′ and generated from the input image A by using the calculated parallax information, may be used. That is, by applying the present invention, it is also possible to generate a three-dimensional image with the image A′ and image A″ which are different and generated from the input image A. This method allows to divide an amount of unspecified pixels generated along with movement of the subject into right and left images. That is, by reducing the maximum value of an area formed of a series of unspecified pixels, it is possible to reduce deterioration of image quality.

As describe above, according to the image capturing apparatus of the present invention, it becomes possible to easily shoot a three-dimensional image in either a horizontal position or a vertical position at low cost without physically rotating imaging elements. Further, a display capable of displaying a three-dimensional image either in a horizontal position or a vertical position is provided, thereby making it possible to perform shooting while confirming an image as a three-dimensional image.

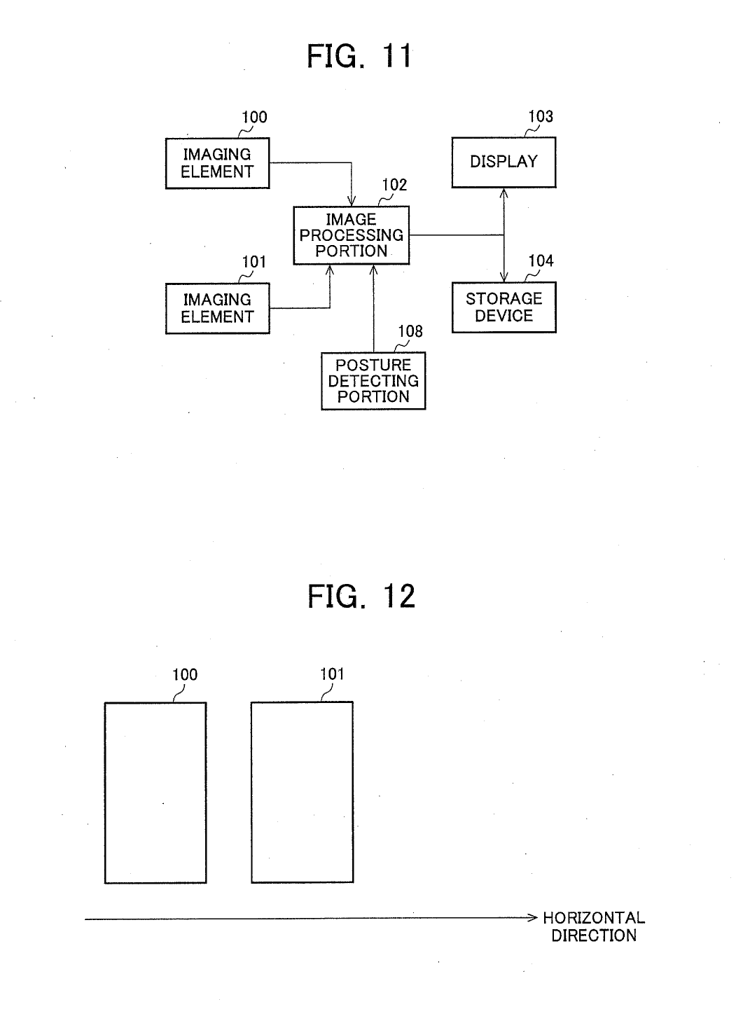

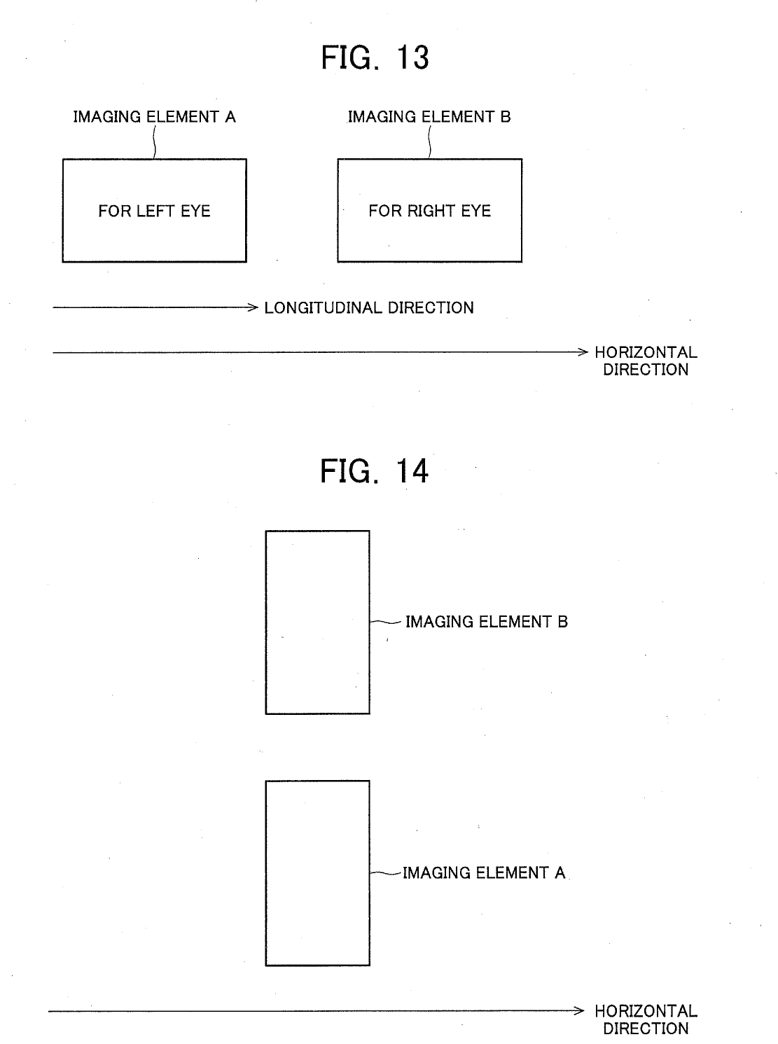

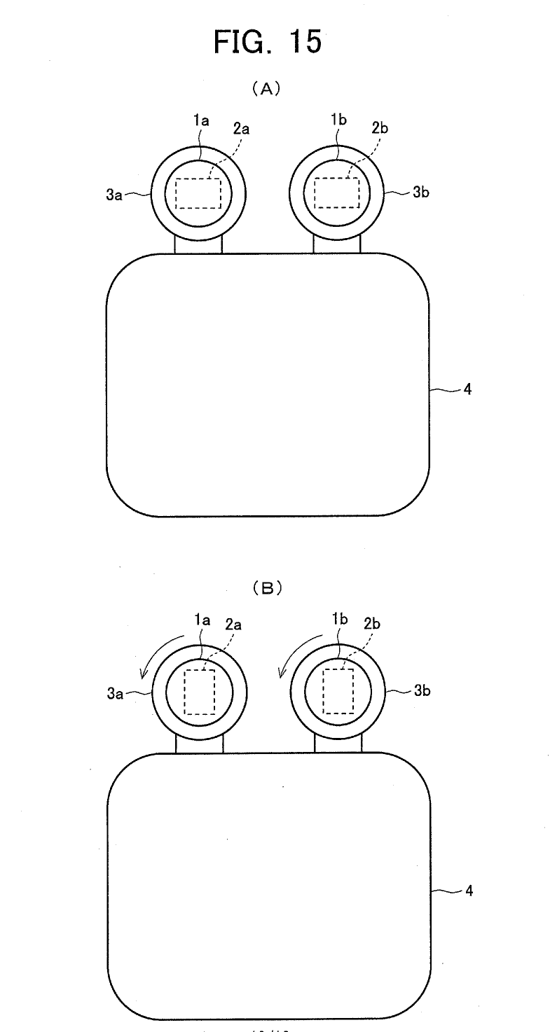

FIG. 11 is a diagram showing a configuration in which a posture detecting portion for detecting posture of the image capturing apparatus is provided. In this example, in addition to the configuration of the image capturing apparatus described above, a posture detecting portion 108 for detecting the horizontal position and the vertical position of the image capturing apparatus is provided. According to information indicating posture (horizontal position or vertical position) of the image capturing apparatus detected by the posture detecting portion 108, the image processing portion 102 automatically switches orientation of shooting to generate a three-dimensional image. An acceleration sensor or the like is applicable to the posture detecting portion 108. In addition, in a digital camera in which a preview screen is rotated, a mobile phone with a camera of a cycloid type, and the like, it is possible to automatically and appropriately switch orientation of shooting by detecting orientation of the display 103.

Although description has been given herein for the case where the longitudinal direction of the imaging element becomes the same as the direction in which the two imaging elements are arranged in the above embodiment, the present invention is also applicable to a case where a short direction of the imaging elements 100 and 101 becomes the same as the direction in which the two imaging elements 100 and 101 are arranged as shown in FIG. 12.

Parallax information is calculated from a shot image of the imaging element 100 and a shot image of the imaging element 101. When it is desired to obtain a three-dimensional image in the vertical position, one of the right and left images is provided as the shot image of the imaging element 101, and the other one of the right and left images is selected from a shot image A of the imaging element A and the image A′ for which the shot image A is subjected to parallax conversion. When it is desired to obtain a three-dimensional image in the horizontal position, it is possible to obtain a three- dimensional image, having right and left images as the shot image A of the imaging element 100 and the image A′ for which the shot image A is subjected to parallax conversion.

Further, in selection of the right and left images when a three-dimensional image is generated, it is possible to obtain a three-dimensional image also by selecting the shot image A and the image A′ for which the shot image A is subjected to parallax conversion regardless of a vertical position or a horizontal position without using the input image B.

However, when a three-dimensional image is generated on an input image B side, in a case where a base line length of the three-dimensional image to be generated is larger than half the base line length between the input image A and the input image B, a movement amount of pixels is smaller in the input image B subjected to parallax conversion rather than the input image A subjected to parallax conversion. Accordingly, when a state where the input image B is usable is provided and the base line length of the three-dimensional image to be generated on the input image B side is larger than half the base line length between the input image A and the input image B, it is more preferable to use the input image B.

Moreover, in order to be capable of appropriately discriminating whether to display in the vertical position or display in the horizontal position when an image recorded in the storage device 104 is reproduced, at the time of recording image data, it is desirable to record at the same time also additional information on whether the image is shot in a vertical position or the image is shot in a horizontal position.

Moreover, it is possible to realize the image processing portion 102 of the present invention by various means for performing image processing, and is also able to be realized, for example, by processing of a CPU with software, by processing with hardware such as LSI and FPGA, and by using the both.

### EXPLANATIONS OF LETTERS OR NUMERALS

1a, 1b . . . shooting lens; 2a, 2b . . . imaging element; 3a, 3b . . . camera head; 100, 101 . . . imaging element; 102 . . . image processing portion; 103 . . . display; 104 . . . storage device; 105 . . . parallax calculating portion; 106 . . . parallax converting portion; 107 . . . output image generating portion; 108 . . . posture detecting portion; and 110 . . . parallax barrier.

1-4. (canceled)

5. An image capturing apparatus, comprising:
two imaging elements; and
an image processing portion which generates an image, wherein
the image processing portion calculates parallax between a first image and a second image captured by the imaging elements, generates an estimation image having parallax in a direction orthogonal to an arrangement direction of the imaging elements with respect to the first image using the calculated parallax and the first image, and generates a three-dimensional image from the estimation image, and
the image capturing apparatus, wherein
the image processing portion switches between processing of generating a three-dimensional image generated from the estimation image having parallax in the direction orthogonal to the arrangement direction of the imaging elements as a first three-dimensional image and
processing of generating a second three-dimensional image from the first and the second images captured by the imaging elements, or from an estimation image that is generated from the first and the second images captured by the imaging elements, and has parallax in the arrangement direction of the imaging elements, and
the image capturing apparatus, wherein the image capturing apparatus includes an image display portion which displays the three-dimensional image generated by the image processing portion and a light control portion which controls advance of image light of the respective two images from which the three-dimensional image is generated when the image display portion displays the three-dimensional image, and
the light control portion switches control of the advance of the image light according to the first three-dimensional image and the second three-dimensional image which are displayed, respectively.

6. The image capturing apparatus as defined in claim 5, wherein the image capturing apparatus includes a posture detecting portion which detects posture of the image capturing apparatus, and
the image processing portion switches between processing of generating the first three-dimensional image and processing of generating the second three-dimensional image according to the posture of the image capturing apparatus detected by the posture detecting portion.
